(19) United States
(12) Patent Application Publication
(10) Pub. No.: US 2006/0187622 A1
(43) Pub. Date: Aug. 24, 2006

(54) Computer keyboard

(76) Inventor: Lin Jia Jing, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/060,428

(22) Filed: Feb. 18, 2005

(51) Int. Cl. G06F 1/16

(52) U.S. Cl. 361/680; 248/118; 361/683

(57) ABSTRACT

A computer keyboard includes a keyboard body removably received and retained in an outer frame assembly. The outer frame assembly includes a rigid base, serving as a lower frame forming a first central cavity and having a front flange, and a soft pad including an upper frame forming a second central cavity and having a wrist support extending from the upper frame. The upper frame is stacked on the lower frame with the central cavities aligned with each other to define a space for receiving the keyboard body. The wrist support that is soft is positioned on and supported by the front flange of the lower frame to in turn support a user's wrists.

### BACKGROUND OF THE INVENTION

1. Field of the Invention

The present invention relates generally to a computer keyboard, and in particular to a computer mouse comprising an outer frame that forms a wrist support having a convex curved cross-section for comfortable operation of the keyboard and enhanced ergonomics of the keyboard.

2. The Related Art

A computer keyboard is one of the most important input devices of a computer system. In operating the computer system with the keyboard, the wrists of a user must be raised up and float in the air. This altitude strains the arm and wrist muscles of the user and eventually causes damage to the user's arm and wrist. To solve the problem, a wrist support that has an inclined top surface is positioned in front of the keyboard to support the user's wrists when the user is operating the keyboard. This effectively enhances operation comfortableness and reduces the strain of muscles.

The wrist support of a conventional keyboard is integrally formed with the keyboard, or alternatively is removably attached to a front edge of the keyboard. Both fixed and removable wrist supports are made of rigid material, which causes uncomfortable contact between the user's wrists and the wrist support. Thus, the conventional wrist support may still hurt the user's wrists.

It is thus desirable to provide a computer keyboard that provides comfortable support to user's wrists so as to overcome the above-discussed problem of the conventional keyboard.

### SUMMARY OF THE INVENTION

Therefore, a primary objective of the present invention is to provide a computer mouse that is of ergonomic construction so as not to hurt users' wrists.

Another objective of the present invention is to provide a computer keyboard that comprises an outer frame having a soft pad for supporting a user's wrists so as to provide a comfortable and ergonomic contact and support for the user's wrist.

A further object of the present invention is to provide a computer keyboard comprising a soft wrist support in which a vibrator is embedded for massaging the user's wrists when the user is operating the keyboard.

To achieve the above objectives, in accordance with the present invention, a computer keyboard comprises a keyboard body and an outer frame assembly removably fit over the keyboard body. The outer frame assembly comprises a rigid base comprising a lower frame that forms a first central cavity having a shape and size corresponding to the keyboard body and having a front flange and a soft pad, which is made of a soft and flexible material, comprising an upper frame that forms a second central cavity having a shape and size corresponding to the keyboard body and a front flange forming a soft wrist support. The upper frame is stacked on and supported by the lower frame with the central cavities aligned with each other to define a space for receiving the keyboard body. The wrist support is positioned on and supported by the front flange of the lower frame for comfortably supporting a user's wrists. If desired, the wrist support may have any desired thickness and may have a convex curved cross-section that assumes a curved surface of any desired curvatures. Patterns and/or textures may be formed on an outside surface of the wrist support for decoration purposes. In addition, if desired, a vibrator can be embedded in the soft wrist support for massaging the user's wrists.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a computer keyboard constructed in accordance with a first embodiment of the present invention;

FIG. 2 is an exploded view of the computer keyboard of the present invention;

FIG. 3 is a side elevational view, in an exploded form and partly broken, of the computer keyboard of the present invention;

FIG. 4 is an assembled view of FIG. 3; and

FIG. 5 is a perspective view of a computer keyboard constructed in accordance with a second embodiment of the present invention.

### DETAILED DESCRIPTION OF THE PREFERRED EMBODIMENT

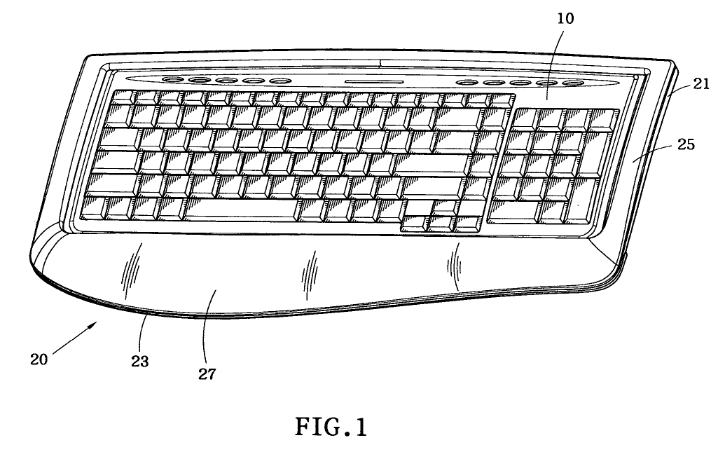

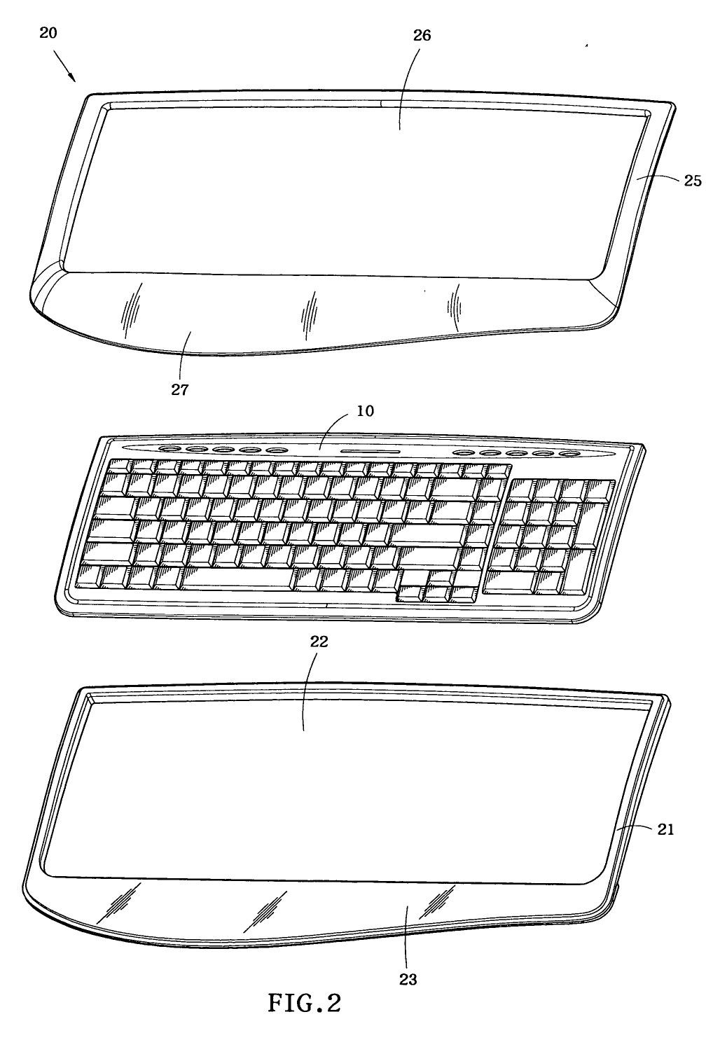

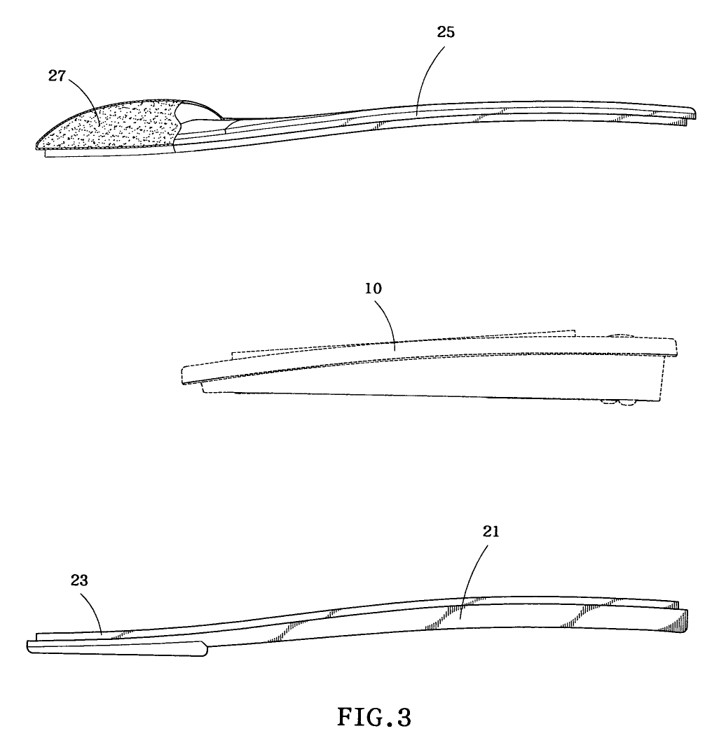

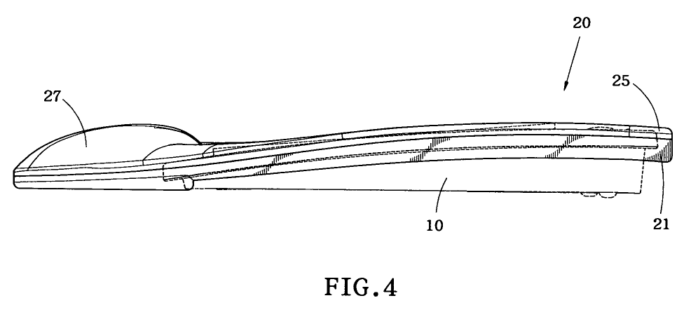

With reference to the drawings and in particular to FIGS. 1-4, a computer keyboard constructed in accordance with the present invention comprises a keyboard body 10, which is in generally a regular keyboard having a rigid casing and a number of pushbuttons or keys floatingly supported on the casing, and an outer frame assembly 20 that is removably fit under and surrounds the keyboard body 10 with the keys of the keyboard body 10 exposed for user's access.

The outer frame assembly 20 comprises a rigid base forming a rigid lower frame 21 and a soft pad forming a soft upper frame 25. The lower frame 21 forms a first central cavity 22 that is sized to receive the keyboard 10 therein. The lower frame 21 has a front flange 23 extending frontward from a front edge of the first central cavity 22. The upper frame 25 is made of soft and flexible materials, forming a second central cavity 26 for receiving the keyboard 10 and having a front flange extending frontward, serving as a wrist support 27 having a concave curved cross-section of a desired thickness and having a predetermined curvature, which provides a concave curved outer surface for comfortably and stably supporting a user's wrists.

The upper frame 25 and the lower frame 21 are preferably of substantially the same configuration and size, and the soft upper frame 25 is stacked over and supported by the rigid lower frame 21. The central cavities 22, 26 of the lower and upper frames 21, 26 correspond in size and position to each other, and thus aligned with each other when the upper frame 25 is stacked on the lower frame 21, thereby defining a continuous space for commonly receiving and accommodating the keyboard body 10.

The wrist support 27 of the upper frame 25 that is made of the soft and flexible materials provides a comfortable and ergonomic contact with the user's wrists and thus supports the wrists in such a manner that reduces straining of the user's muscles, as well as enhancing operation of the keyboard by the user's hands.

It is apparent to those having ordinary skills to shape the wrist support 27 as desired so as to fit the needs of different users, such as changing thickness of the wrist support and curving the outer surface of the wrist support with different curvatures, thereby enhancing the effect of supporting the user's wrists and improving ergonomic effects. In addition, patterns, such as texture, figure, and texts, may be provided on the outer surface of the wrist support 27 for decoration.

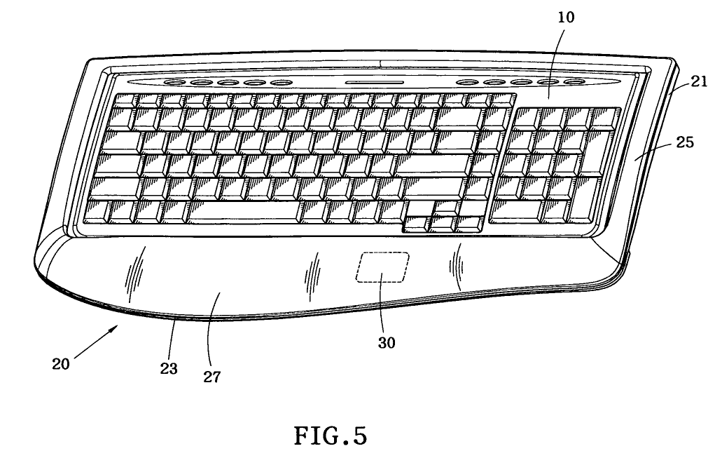

Referring to FIG. 5, if desired, a vibrator 30 can be arranged inside or embedded in the wrist support 27 that is made of soft and flexible materials. The vibrator 30 induces vibration of the soft materials of the wrist support 27, which allows the wrist support 27 to massage the user's wrists when the user is operating the keyboard body 10 with his or her hands. An ON/OFF switch (not shown) for the vibrator 30 may be provided for selectively turning on/off the vibrator 30. Or alternatively, a pressure sensor (not shown) arranged inside the wrist support 27 can be used to actuate the vibrator 30 in response to a depressing force applied to the wrist support 27 by the weight of the user's wrists.

To summarize, the computer keyboard in accordance with the present invention provides a regular keyboard with an outer frame that comprises a wrist support made of soft and flexible materials for more comfortably and ergonomically supporting the user's wrist thereby enhancing operation of the keyboard by the user's hand. In addition, the vibrator 30 that is embedded in the wrist support 27 allows the wrist support 27 to perform an additional function of massaging the user's wrists, which further releases the strain of the user's muscles, thus adding value to the computer keyboard.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A computer keyboard comprising:
a keyboard body; and
an outer frame assembly comprising:
a base comprising a lower frame forming a first central cavity having a shape and size corresponding to the keyboard body and having a front flange, and
a soft pad made of a soft and flexible material, comprising an upper frame that forms a second central cavity having a shape and size corresponding to the keyboard body and a front flange forming a soft wrist support, the upper frame being stackable over the lower frame with the first and second central cavities aligned with each other to define a space for receiving the keyboard body, the wrist support being positionable on and supported by the front flange of the lower frame for comfortably supporting a user's wrists.

2. The computer keyboard as claimed in claim 1, wherein the wrist support is made of a soft material of a predetermined thickness and having a predetermined convex curved cross-section that forms a curved surface of a predetermined curvature.

3. The computer keyboard as claimed in claim 1, wherein the wrist support has an outside surface on which patterns and/or textures are formed.

4. The computer keyboard as claimed in claim 1 further comprising a vibrator embedded in the soft wrist support.
